(19) United States
(12) Patent Application Publication
(10) Pub. No.: US 2025/0045892 A1
(43) Pub. Date: Feb. 6, 2025

(54) VARIATIONAL INFERENCING BY A DIFFUSION MODEL

(71) Applicant: NVIDIA Corporation, Santa Clara, CA (US)

(72) Inventors: Morteza Mardani, Santa Clara, CA (US); Jiaming Song, San Carlos, CA (US); Jan Kautz, Lexington, MA (US); Arash Vahdat, San Mateo, CA (US)

(21) Appl. No.: 18/593,742

(22) Filed: Mar. 1, 2024

Related U.S. Application Data
(60) Provisional application No. 63/452,646, filed on Mar. 16, 2023.

(51) Int. Cl. G06T 7/00; G06T 3/40; G06T 5/70; G06T 5/73; G06T 5/77

(52) U.S. Cl. CPC G06T 7/0002; G06T 3/40; G06T 5/70; G06T 5/73; G06T 5/77; G06T 2207/30168

(57) ABSTRACT

Diffusion models are machine learning algorithms that are uniquely trained to generate high-quality data from an input lower-quality data. For example, they can be trained in the image domain, for example, to perform specific image restoration tasks, such as inpainting (e.g. completing an incomplete image), deblurring (e.g. removing blurring from an image), and super-resolution (e.g. increasing a resolution of an image), or they can be trained to perform image rendering tasks, including 2D-to-3D image generation tasks. However, current approaches to training diffusion models only allow the models to be optimized for a specific task such that they will not achieve high-quality results when used for other tasks. The present disclosure provides a diffusion model that uses variational inferencing to approximate a distribution of data, which allows the diffusion model to universally solve different tasks without having to be re-trained specifically for each task.

### CLAIM OF PRIORITY

This application claims the benefit of U.S. Provisional Application No. 63/452,646 (Attorney Docket No. NVIDP1376+/23-SC-0255US01) titled “SOLVING INVERSE PROBLEMS WITH DIFFUSION MODELS,” filed Mar. 16, 2023, the entire contents of which is incorporated herein by reference.

### TECHNICAL FIELD

The present disclosure relates to solving inverse problems using diffusion models.

### BACKGROUND

Diffusion models are machine learning algorithms that are uniquely trained to generate high-quality data, and for this reason these models have emerged as a key pillar for computer vision tasks. Diffusion models are typically trained by gradually adding (Gaussian) noise to an original input data in a forward diffusion process and then learning to remove the noise in a reverse diffusion process. The trained diffusion model can then process an input low-quality data (e.g. having noise) to generate a higher-quality version of the data. This is often referred to as an inverse task.

Diffusion models can be trained in the image domain, for example, to perform specific image restoration tasks, such as inpainting (e.g. completing an incomplete image), deblurring (e.g. removing blurring from an image), and super-resolution (e.g. increasing a resolution of an image). Diffusion models can also be trained to perform image rendering tasks, including two-dimensional to three-dimensional (2D-to-3D) tasks in which a 3D image is generated from a 2D image. However, traditional approaches used for training diffusion models only allow the models to be optimized for a specific task. This means that the trained diffusion model will not achieve high-quality results when used for other tasks.

To expand the usability of diffusion models, it has been a goal to generate a single diffusion model that can universally solve different inverse tasks without having to re-train the model specifically for each task. Unfortunately, current approaches to develop universal diffusion models for inverse problems are limited. For example, some models are able to only handle linear inverse problems in which the output will be directly proportional to the input (per some affine function). On the other hand, models that are adapted for nonlinear inverse problems, where the relationship between input and output is more complex and cannot be expressed as a simple linear function, rely heavily on loose approximations.

There is a need for addressing these issues and/or other issues associated with the prior art. For example, there is a need to provide a diffusion model that uses variational inferencing to approximate the distribution of data, where such variational inferencing can promote regularization by the reverse diffusion process.

### SUMMARY

A method, computer readable medium, and system are disclosed to provide a diffusion model that uses variational inferencing to approximate the distribution of data. At least one observation is processed through a reverse denoising diffusion process of a diffusion model to approximate a distribution of data for the at least one observation, where the diffusion model uses variational inference to approximate the distribution of data. The distribution of data is then output.

### BRIEF DESCRIPTION OF THE DRAWINGS

FIG. 1 illustrates a flowchart of a method to provide a diffusion model that uses variational inferencing to approximate the distribution of data, in accordance with an embodiment.

FIG. 2 illustrates a flowchart of a method of forward and reverse processes of a diffusion model that uses variational inferencing to approximate the distribution of data, in accordance with an embodiment.

FIG. 3 illustrates a denoiser configuration of a diffusion model that uses variational inferencing to approximate a distribution of data, in accordance with an embodiment.

FIG. 4 illustrates a flowchart of a method of a score-matching regularization applied by each of the denoisers of FIG. 3, in accordance with an embodiment.

FIG. 5 illustrates a block diagram of a diffusion model process that uses variational inferencing to approximate the distribution of data in an image, in accordance with an embodiment.

FIG. 6 illustrates exemplary algorithm for a diffusion model process that uses variational inferencing to approximate the distribution of data, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

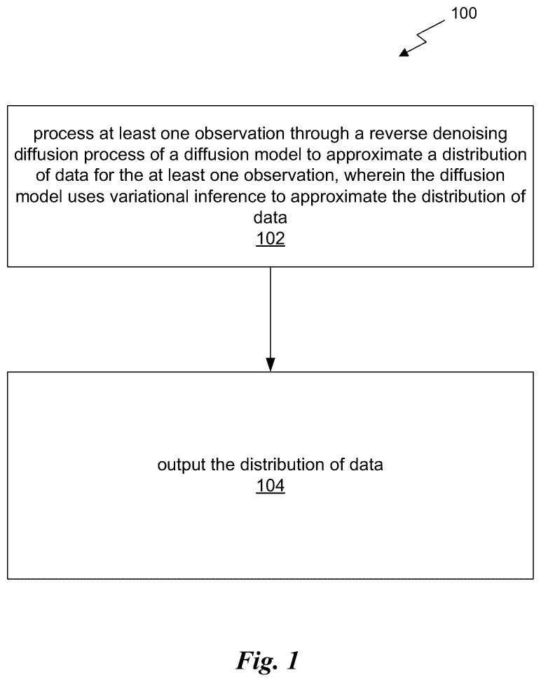

FIG. 1 illustrates a flowchart of a method 100 to provide a diffusion model that uses variational inferencing to approximate the distribution of data, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

As mentioned, the method 100 relates specifically to providing (e.g. training), a diffusion model. The diffusion model refers to a machine learning model that can generate data from noise. The noise refers to (e.g. random or pseudo-random) artifacts that are present in the data. In an embodiment, the diffusion model may be a generative diffusion prior that learns to approximate a distribution of data for any given input at inference time.

At training time, the diffusion model includes a forward diffusion process (also referred to herein as a “forward denoising diffusion process”) in which noise is added to an input data (also referred to herein as an “input data distribution”). In particular, the noise (e.g. randomly) replaces portions of the input data, which may be done slowly over multiple timesteps. The noise may be Guassian noise, where the values that the noise can take fall under a Gaussian distribution, in an embodiment. Also at training time, the diffusion model includes a reverse diffusion process in which the model learns to remove the noise in order to generate, or restore, the data. The reverse diffusion process may also be done slowly over multiple timesteps (e.g. over the same number of timesteps as were used in the forward diffusion process). The present method 100, as described below, introduces variational inferencing to the reverse diffusion process (also referred to herein as a “reverse denoising diffusion process”).

In operation 102, at least one observation is processed through a reverse denoising diffusion process of a diffusion model to approximate a distribution of data for the at least one observation, where the diffusion model uses variational inference to approximate the distribution of data. The observation refers to data generated by a forward denoising diffusion process of the diffusion model. Accordingly, in the present embodiment, the observation at least partially includes noise. In an embodiment, the observation may be an image (e.g. in 2D or 3D) or may be included in at least a portion of an image. An image refers to a single image (e.g. captured by a camera or otherwise digitally generated) or an image frame from a video. In another embodiment, the observation may be audio.

The noise may present itself in the observation in various ways. For example, the noise may cause the observation to have a reduced resolution (when compared to the input data). As another example, the noise may be presented as a mask in one or more portions of the observation (i.e. that masks one or more portions of the input data).

As described above, the reverse denoising diffusion process of the diffusion model operates such that the model learns to remove the noise from the observation(s), and in particular such that a distribution of data is approximated for the observation(s). The distribution of data may be an approximation of the original data input to the forward diffusion process, in an embodiment. In various examples, the distribution of data may represent an output image, a non-masked image, a 3D image, a higher-resolution data, etc.

In the context of the present description, the diffusion model uses variational inference to approximate the distribution of data. Variational inference refers to varying one or more aspects of the model during the reverse denoising diffusion process. In an embodiment, weights may be varied during the reverse denoising diffusion process. For example, the weights may be varied over one or more timesteps of the reverse denoising diffusion process. In an embodiment, each timestep of the reverse denoising diffusion process may utilize a corresponding denoiser that is weighted based on a denoising signal-to-noise ratio at the timestep. The signal-to-noise ratio refers to a ratio of data points to noisy points in a current input to the denoiser. As the signal-to-noise ratio increases, the weights may be configured to decrease. Accordingly, in an embodiment, denoiser weights may progressively decrease through the reverse denoising diffusion process.

In an embodiment, each timestep of the reverse denoising diffusion process may also utilize a corresponding denoiser that applies score-matching regularization to a measurement matching loss. In an embodiment, the measurement matching loss may be a reconstruction loss computed from the observation(s). In an embodiment, a diffusion trajectory is used for regularization.

In operation 104, the distribution of data is then output. In an embodiment, the distribution of data may be output back to the forward denoising diffusion process of the diffusion model. For example, the distribution of data may be processed through the forward denoising diffusion process of the diffusion model to form at least one second observation. In turn, the second observation(s) may be processed through the reverse denoising diffusion process to approximate a second distribution of data for the second observation(s). In this way, the method 100 may be repeated for the second observation(s), which may provide fine-tuning of the diffusion model.

By using variational inferencing during the reverse denoising diffusion process, the method 100 may result in a diffusion model that is usable for different downstream tasks. In other words, the diffusion model may be universally applied to various downstream tasks without having to be re-trained for each individual one of the downstream tasks. These downstream tasks may include image restoration, such as inpainting (e.g. completing an incomplete image), super-resolution (e.g. increasing a resolution of an image or other data), deblurring (e.g. removing at least some blurring from an image), sharpening (e.g. sharpening edges in at least a portion of an image), etc. In another example, the downstream tasks may include 2D-to-3D image generation. The downstream tasks may have applications in medical imaging, autonomous driving, robotics, or any other application requiring images with a certain quality level and/or requiring images in 3D.

An exemplary implementation of the method 100 may include processing at least a portion of an image (i.e. as at least one observation) through the reverse denoising diffusion process to approximate an output image (i.e. as a distribution of data for the image or portion thereof). Another exemplary implementation of the method 100 may include processing a masked, or incomplete, image (i.e. as at least one observation) through the reverse denoising diffusion process to approximate a non-masked, or complete, image (i.e. as a distribution of data for the masked image). Another exemplary implementation of the method 100 may include processing a 2D image (i.e. as at least one observation) through the reverse denoising diffusion process to approximate a 3D image (i.e. as a distribution of data for the 2D image). Another exemplary implementation of the method 100 may include processing a lower-resolution image (or other data) through the reverse denoising diffusion process to approximate a higher-resolution image (or other data).

In one implementation of the method 100, the diffusion model is trained to be able to improve a quality of any given input image. In this exemplary implementation, the training includes adding random noise to an input image over a plurality of steps of a forward diffusion process, to form a noisy image, and then learning to remove the noise from the noisy image over a plurality of steps of a reverse diffusion process, where one or more aspects of the diffusion model are varied over one or more of the steps of the reverse diffusion process to provide variational inferencing during the reverse diffusion process. In an embodiment, the forward and reverse processes may be repeated using the output of the prior reverse diffusion process. In this exemplary implementation, the trained diffusion model may be universally able to handle different types of image improvement tasks, such as inpainting (to complete a given input incomplete image), super-resolution (to increase a resolution of a given input image), and/or deblurring (to remove blurring from a given input image).

Further embodiments will now be provided in the description of the subsequent figures. It should be noted that the embodiments disclosed herein with reference to the method 100 of FIG. 1 may apply to and/or be used in combination with any of the embodiments of the remaining figures below.

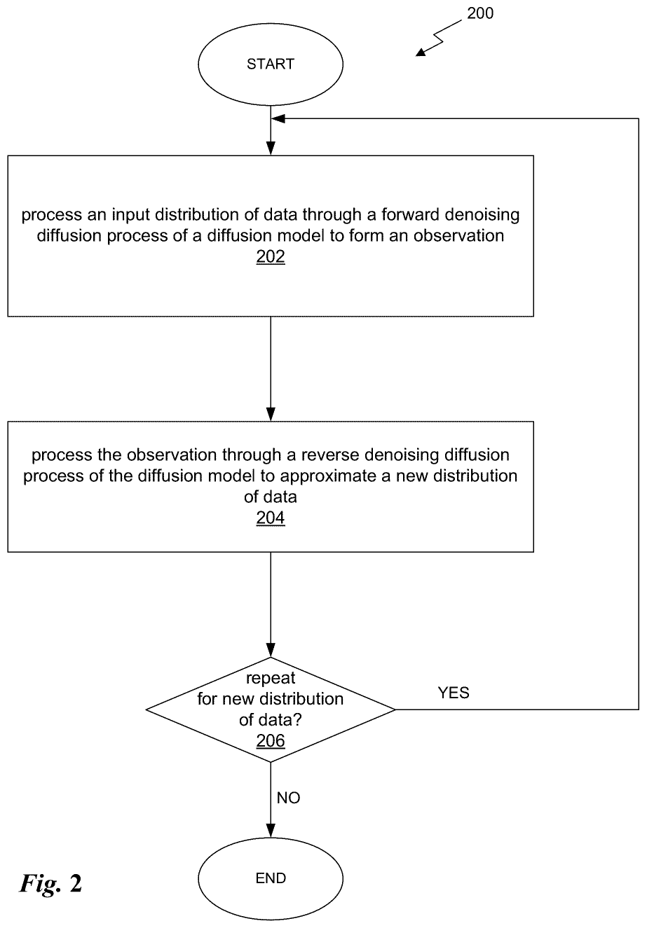

FIG. 2 illustrates a flowchart of a method 200 of forward and reverse processes of a diffusion model that uses variational inferencing to approximate the distribution of data, in accordance with an embodiment. The method 200 may be carried out in the context of the method 100 of FIG. 1, in an embodiment. Further, the descriptions and/or definitions given above may equally apply to the present embodiment.

In operation 202, an input distribution of data (e.g. an input image) is processed through a forward denoising diffusion process of a diffusion model to form an observation (e.g. a noisy image). The forward denoising diffusion process gradually adds noise to the input distribution of data, in an embodiment. In an embodiment, the noise is added to the input distribution of data over a plurality of steps. In an embodiment, the noise is Guassian noise, where the values that the noise can take fall under a Gaussian distribution, in an embodiment.

In operation 204, the observation (e.g. noisy image) is processed through a reverse denoising diffusion process to approximate a new distribution of data (e.g. an output non-noisy image). The new distribution of data may be an approximation of the input distribution of data. In an embodiment, the reverse denoising diffusion process gradually removes the noise from the observation. In an embodiment, the noise is removed from the observation over a plurality of steps.

With respect to the present embodiment, the reverse denoising diffusion process employs variational inferencing. In this regard, different denoiser weights may be applied for one or more steps of the reverse denoising diffusion process. The effect of the denoising diffusion process is that the diffusion model learns to approximate the new distribution of data from the given observation generated during the forward denoising diffusion process. This learning process trains the diffusion model to generate (e.g. non-noisy) data from given noisy input data.

In decision 206, it is determined whether to repeat the method 200 for the new distribution of data. This decision 206 may be made based on a preconfigured stopping criteria. For example, the stopping criteria may indicate an maximum threshold of error allowed between the original input distribution of data and the new distribution of data. If the stopping criteria is met, then the method 200 may terminate. If the stopping criteria is not met, then the method 200 may be repeating by inputting the new distribution of data to the forward denoising diffusion process for processing thereof (returning to operation 202).

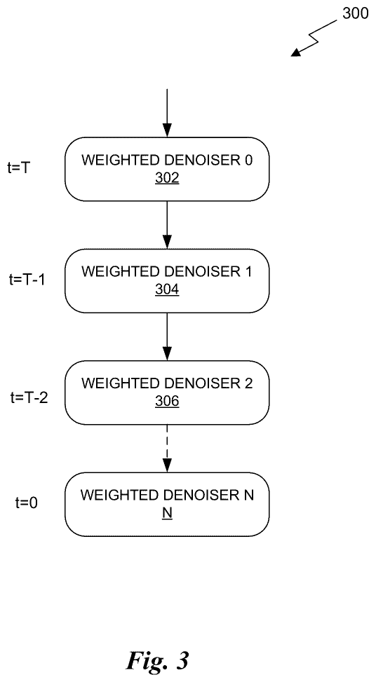

FIG. 3 illustrates a denoiser configuration 300 of a diffusion model that uses variational inferencing to approximate a distribution of data, in accordance with an embodiment. The denoiser configuration 300 may be implemented to carry out the reverse denoising diffusion process described in the method 100 of FIG. 1 and/or the method 200 of FIG. 2, in one or more embodiments. Again, the descriptions and/or definitions given above may equally apply to the present embodiment.

As shown, the diffusion model includes a plurality of denoisers 302-N, each corresponding to a different timestep (t) in a reverse denoising diffusion process of the diffusion model. In an embodiment, a different denoiser may be employed for each timestep of the reverse denoising diffusion process. The denoisers 302-N are configured in a sequence to gradually predict and remove noise from an original observation input to the reverse denoising diffusion process. For example, a denoiser 302 at timestep T predicts and removes noise from the original observation input to the reverse denoising diffusion process, to generate a result of a partially denoised observation. The result is then input to the next denoiser 304 in sequence (shown at timestep T−1) to further predict and remove noise from the prior partially denoised observation. This process repeats through a last denoiser N at timestep 0.

As also shown, each denoiser 302-N is weighted. In the present embodiment specifically, each denoiser 302-N is configured with different weights. For example, each timestep of the reverse denoising diffusion process may utilize a corresponding denoiser 302-N that is weighted based on (i.e. as a function of) a denoising signal-to-noise ratio at the timestep. As the signal-to-noise ratio increases, the weights may be configured to decrease. Accordingly, in an embodiment, the denoiser 302-N weights may progressively decrease through the reverse denoising diffusion process.

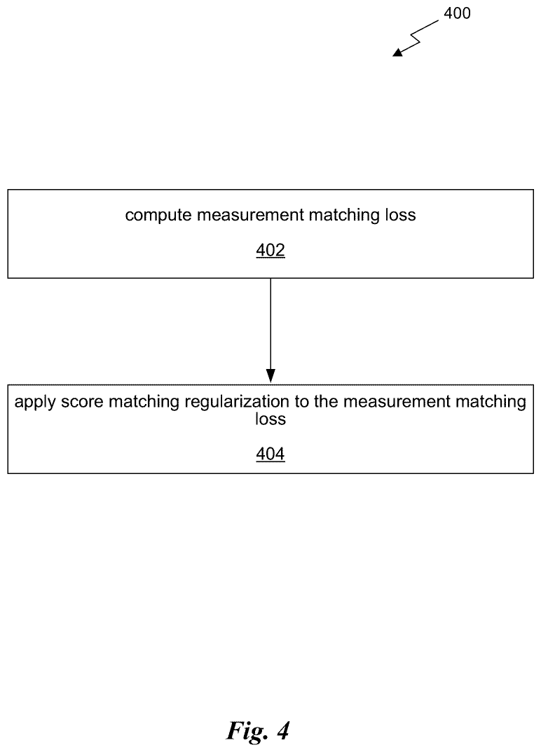

FIG. 4 illustrates a flowchart of a method 400 of a score-matching regularization applied by each of the denoisers 302-N of FIG. 3, in accordance with an embodiment. It should be noted that the score-matching regularization described herein is just one possible embodiment of the criteria that can be used by the denoisers 302-N to evaluate their denoising performance.

In operation 402, a measurement matching loss is computed. The measurement matching loss computed by a denoiser 302-N is computed between that denoiser's 302-N denoised observation and the non-noisy distribution of data originally input to the forward denoising diffusion process of the diffusion model. This measurement matching loss may be referred to as a reconstruction loss.

In operation 404, score-matching regularization is applied to the measurement matching loss. The score-matching regularization uses feedback from all prior steps in the reverse denoising diffusion process which are associated with different noise levels. For example, in an embodiment, a diffusion trajectory may be used for the regularization.

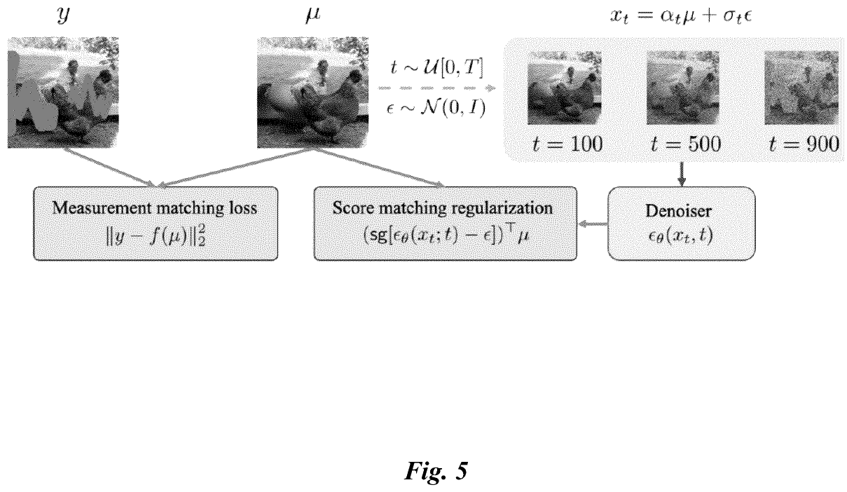

FIG. 5 illustrates a block diagram of a diffusion model process 500 that uses variational inferencing to approximate the distribution of data in an image, in accordance with an embodiment. The diffusion model process 500 may be carried out by the diffusion model described above in FIG. 1.

As shown, the diffusion model includes a forward denoising diffusion process in which noise is gradually added to an estimate μ. The forward denoising diffusion process is performed over a plurality of steps from timestep t to timestep T. Formally, the forward process can be expressed by the variance preserving stochastic differential equation

$$dx = - \frac{1}{2} β ( t ) xdt + \sqrt{β ( t )} dw$$

$$for$$

$$t \text{=∈} [ 0 , T ]$$

$$where$$

$$β ( t ) := {β}_{min} + ( {β}_{max} - {β}_{min} ) \frac{t}{T}$$

rescales the time variable, and dw is the standard Wiener process. The forward process is designed such that the distribution of x_{T} at the end of the process converges to a standard Gaussian distribution (i.e., x_{T}˜N(0, I)).

In the reverse process, the model learns to generate images by iterative denoising. The reverse process is defined by

$$dx = - \frac{1}{2} β ( t ) xdt + β ( t ) {∇}_{{x}_{t}} log p ( {x}_{t} ) + \sqrt{β ( t )} d \overline{w}$$

$$where$$

$${∇}_{{x}_{t}} log p ( {x}_{t} )$$

is the score function of diffused data at time t, and dw̅ is the reverse standard Wiener process.

Solving the reverse generative process requires estimating the score function. In practice, this is done by sampling from the forward diffusion process and training the score function using the denoising score-matching objective. Specifically, diffused samples are generated by Equation 1.

$${x}_{t} = {α}_{t} {x}_{0} + {σ}_{t} ϵ , \qquad Equation 1$$

$$ϵ ∼ N ( 0 , I ) ,$$

$$t ∈ [ 0 , T ]$$

where x₀˜p_{data} is drawn from data distribution σₜ=1−e^{∫}^{₀}^{^{t}}^{β(s)ds}, and at \sqrt{1−σₜ²}. The parameterized score function (i.e., diffusion model) can be denoted by ∈_{θ}(xₜ; t)≈−σₜ∇ₓ_{ₜ} log p(xₜ) with parameters θ, and ∈_{θ}(xₜ; t) can be trained using a loss weighting function for t. Given the trained score function, samples can be generated.

In general, an inverse problem is often formulated as finding x₀ from a (nonlinear and noisy) observation, per Equation 2.

$$y = f ( {x}_{0} ) + v , v ∼ N ( 0 , {σ}_{v}^{2} I ) \qquad Equation 2$$

Where the forward (i.e. measurement) model f is known. In an embodiment, the prior offered by (pretrained) diffusion models can be leveraged in a plug-and-play fashion, to efficiently sample from the conditional posterior. With the prior distributions imposed by diffusion models as p(x₀), the measurement models can be represented by p(y|x₀): +N(f(x₀), σᵥ². The goal of solving inverse problems is to sample from the posterior distribution p(y|x₀). As mentioned, diffusion models rely on the estimated score function to generate samples. In the presence of the measurements y, they can be used for generating plausible x₀˜p(x₀|y) as long as an approximation of the conditional score for p(xₜ|y) over all diffusion steps is available. Specifically, the conditional score for p(xₜ|y) based on Bayes rule is simply obtained per Equation 3.

$${∇}_{x} log p ( {x}_{t} \vert y ) = {∇}_{x} log p ( y \vert {x}_{t} ) + {∇}_{x} log p ( {x}_{t} ) \qquad Equation 3$$

The overall score is a superposition of the model likelihood and the prior score. While ∇ₓ log p(xₜ) is easily obtained from a pretrained diffusion model, the likelihood score is quite challenging and intractable to estimate without any task-specific training.

To address the issue with sampling the conditional posterior p(y|x₀), we propose a variational approach based on Kullback-Leibler (KL) minimization per Equation 4.

$$\begin{matrix}min \\ q\end{matrix} KL ( q ( {x}_{0} \vert y ) \vert \vert p ( {x}_{0} \vert y ) ) \qquad Equation 4$$

where q: +N(μ, σ²I) is a variational distribution. The distribution q seeks the dominant mode in the data distribution that matches the observations. The KL objective in Equation 4 can be expanded as Equation 5.

$$Equation 5$$

$$KL ( q ( {x}_{0} \vert y ) \vert \vert p ( {x}_{0} \vert y ) ) = {\underbrace{- {𝔼}_{q ( {x}_{0} \vert y )} [ log ( y \vert {x}_{0} ) ] + KL ( q ( {x}_{0} \vert y ) \vert \vert p ( {x}_{0} ) )}}_{term ( i )} + {\underbrace{log p ( y )}}_{term ( ii )}$$

where term (i) is the variational bound and term (ii) is the observation likelihood that is constant with respect to q. Thus, to minimize the KL divergence shown in Equation 4 with respect to q, it suffices to minimize the variational bound (term (i)) in Equation 5 with respect to q.

Proposition 1. The KL minimization with respect to q in Equation 4 is equivalent to minimizing the variational bound (term (i) in Equation 5), that itself obeys the score matching loss per Equation 6.

$$Equation 6$$

$$\begin{matrix}min \\ \{ μ , σ \}\end{matrix} {𝔼}_{q ( {x}_{0} \vert y )} ⌈ \frac{{‖ y - f ( {x}_{0} ) ‖}_{2}^{2}}{2 {σ}_{2}^{2}} ⌉ + {\int }_{0}^{T} \tilde{w} ( t ) {𝔼}_{q ( {x}_{t} \vert y )} [ {‖ {∇}_{{x}_{t}} log q ( {x}_{t} \vert y ) - {∇}_{{x}_{t}} log p ( {x}_{t} ) ‖}_{2}^{2} ] dt$$

where q(xₜ|y)=N(αₜμ,(αₜ² σₜ²)I) produces samples xₜ by drawing x₀ from q(x₀|Y) and applying the forward process in Equation 1, and \tilde{ω}(t)=β(t)/2 is a loss-weighting term.

Above, the first term is the measurement matching loss (i.e., reconstruction loss) obtained by the definition of p(y|x₀), while the second term is obtained by expanding the KL term in terms of the score-matching objective, and \tilde{ω}(t)=β(t)/2 is a weighting based on maximum likelihood. The second term can be considered as a score-matching regularization term imposed by the diffusion prior. The integral is evaluated on a diffused trajectory, namely xₜ˜q(xₜ|y) for t∈[0, T], which is the forward diffusion process applied to q(x₀|y). Since q(x₀|y) admits a simple Gaussian form, it can be shown that q(xₜ|y) is also a Gaussian in the form q(xₜ|y)=N(αₜμ, (αₜ²σₜ²)I). Thus, the score function ∇ₓ_{ₜ} log q(xₜ|y) can be computed analytically.

Assuming that the variance of the variational distribution is a small constant value near zero (i.e., σ≈0), the optimization problem in Equation 6 can be further simplified to Equation 7.

$$\begin{matrix}min \\ \{ μ , σ \}\end{matrix} {\underbrace{{‖ y - f ( μ ) ‖}^{2}}}_{recon} + {𝔼}_{t , ϵ} {\underbrace{[ 2 ω ( t ) {( \frac{{σ}_{v}}{{σ}_{t}} )}^{2} {‖ {ϵ}_{t} ( {x}_{t} ; t ) - ϵ ‖}_{2}^{2} ]}}_{reg} \qquad Equation 7$$

where xₜ=αₜμ+σₜ∈. Solving this optimization problem will find an image μ that reconstructs the observation y given the measurement modelf, while having a high likelihood under the prior as imposed by the regularization term.

### Sampling as Stochastic Optimization

The regularized score matching objective in Equation 7 allows sampling to be formulated as optimization for inverse problems. In essence, the ensemble loss over different diffusion steps advocates for stochastic optimization as a suitable sampling strategy.

In an embodiment, the choice of weighting term \tilde{ω}(t) plays a key role in the success of this optimization problem. Reweighting the objective over t plays a key role in trading content versus detail at different diffusion steps, which is described in more detail below. Additionally, the second term in Equation 7 marked by “reg” requires backpropagating through pretrained score function which can make the optimization slow and unstable.

In another embodiment, a generic weighting mechanism \tilde{w}(t)=β(t)ω(t)/2 may be used for a positive-valued function ω(t), where if the weighting is selected such that ω(0)=0, then the gradient of the regularization term can be computed efficiently without backpropagating through the pretrained score function.

Proposition 2. If ω(0)=0 and σ=0, then the gradient of the score matching regularization loss admits Equation 8.

$${∇}_{μ} reg ( μ ) = {𝔼}_{f ∼ μ [ 0 , T ] , ϵ ∼ N ( 0 , I )} [ {λ}_{t} ( {ϵ}_{θ} ( {x}_{t} ; t ) - ϵ ) ]$$

$$where$$

$${λ}_{t} := \frac{2 T {σ}_{v}^{2} {α}_{t}}{{σ}_{t}} \frac{d ω ( t )}{dt} .$$

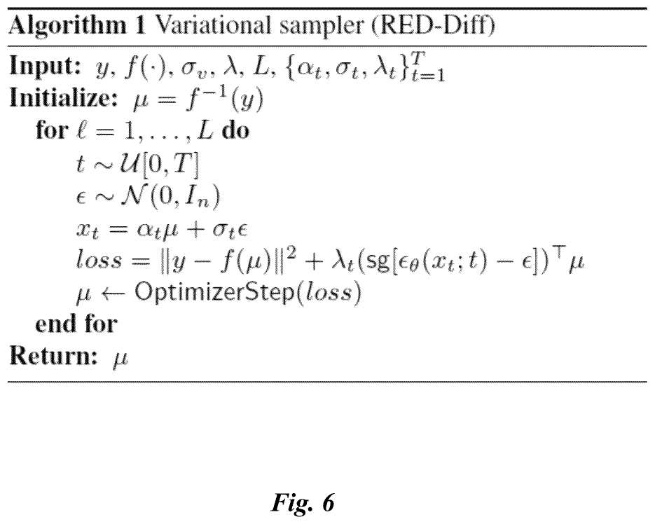

First-order stochastic optimizers. Based on the simple expression for the gradient of score-matching regularization in Proposition 2, time can be treated as a uniform random variable. Thus by sampling randomly over time and noise, unbiased estimates of the gradients can be easily obtained. Accordingly, first-order stochastic optimization methods can be applied to search for μ. The iterates as listed under Algorithm 1 in FIG. 6. Note that the loss is defined per timestep based on the instantaneous gradient, which can be treated as a gradient of a linear loss. The notation (sg) is introduced as stropped-gradient to emphasize that score is not differentiated during the optimization. In an embodiment, descending time stepping from t=T to t=0, as in standard backward diffusion samplers, performs better than random time sampling.

Note that Proposition 2 derives the gradient for the case with no dispersion (i.e., o-=0) for simplicity. The extension to nonzero dispersion may also be considered in an embodiment.

### Regularization by Denoising

From the gradient expression in Proposition 2, the loss at timestep t can be formed per Equation 9.

$${‖ y - f ( μ ) ‖}^{2} + {λ}_{t} ( {sg [ {ϵ}_{θ} ( {x}_{t} ; t ) - ϵ ]}^{⊤} μ \qquad Equation 9$$

A small regularization term implies that either the diffusion reaches the fixed point, namely ∈_{θ}(xₜ; t), or the residual only contains noise with no contribution left from the image. The gradient of the regularizer is quite simple and tractable. Further, as described in the embodiments above, the diffusion prior can be configured to have a generative nature, and the entire diffusion trajectory may also be used for regularization.

### Weighting Mechanism

In principle, timestep weighting plays a key role in training diffusion models. Different timesteps are responsible for generating different structures ranging from large-scale content in the last timesteps to fine-scale details in the earlier timesteps. For effective regularization, the denoiser weights {λₜ} are properly tuned, as shown in Algorithm 1 of FIG. 6. The regularization term in Equation 9 is sensitive to noise schedule. For example, in the variance-preserving scenario, it drastically bellows up as t approaches zero.

To mitigate the regularization sensitivity to weights, the regularization may be defined in the signal domain, which is compatible with the fitting term as per Equation 10.

$${‖ y - f ( μ ) ‖}^{2} + λ ( {sg [ μ - {\hat{μ}}_{t} ]}^{⊤} μ \qquad Equation 10$$

where λ is a hyperparameter that balances between the prior and likelihood and \hat{μ}ₜ is the minimum mean square error (MMSE) predictor of clean data. In an embodiment, it is desired that the constant λ control the trade-off between bias (fit to observations) and variance (fit to prior). In order to come up with the interpretable loss in Equation 10, the noise residual term ∈θ(xₜ; t) can be resCaled.

Recall that the denoiser at time t observes xₜ=αₜx₀+σₜ ∈. The MMSE estimator also provides denoising as per Equation 11.

$${\hat{μ}}_{t} = 𝔼 [ μ \vert {x}_{t} ] = \frac{1}{{α}_{t}} ( {x}_{t} - {σ}_{t} {ϵ}_{θ} ( {x}_{t} ; t ) ) \qquad Equation 11$$

From this, Equation 12 can be shown.

$$μ - {\hat{μ}}_{t} = ( {σ}_{t} / {α}_{t} ) ( {ϵ}_{θ} ( {x}_{t} ; t ) - ϵ ) \qquad Equation 12$$

where SNRₜ:=σₜ/αₜ is defined as the signal-to-noise ratio. Accordingly, by choosing λₜ=Δ/SNRₜ, the noise prediction formulation in Equation 9 can be converted to the clean data formulation in Equation 10.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

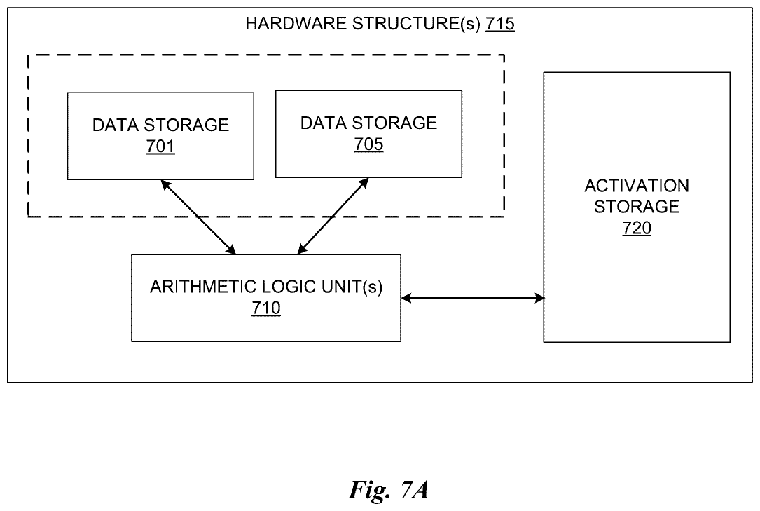

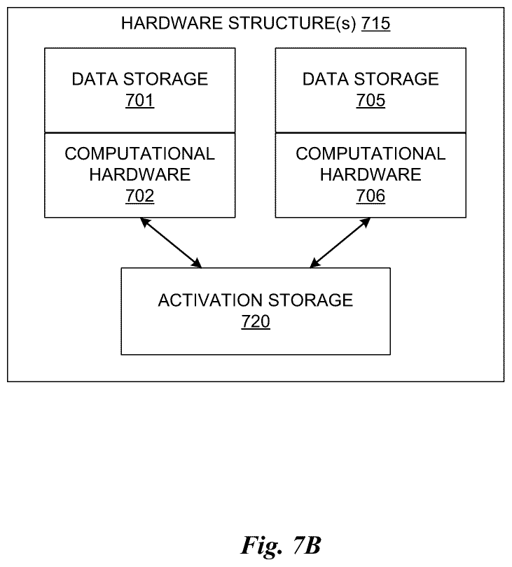

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

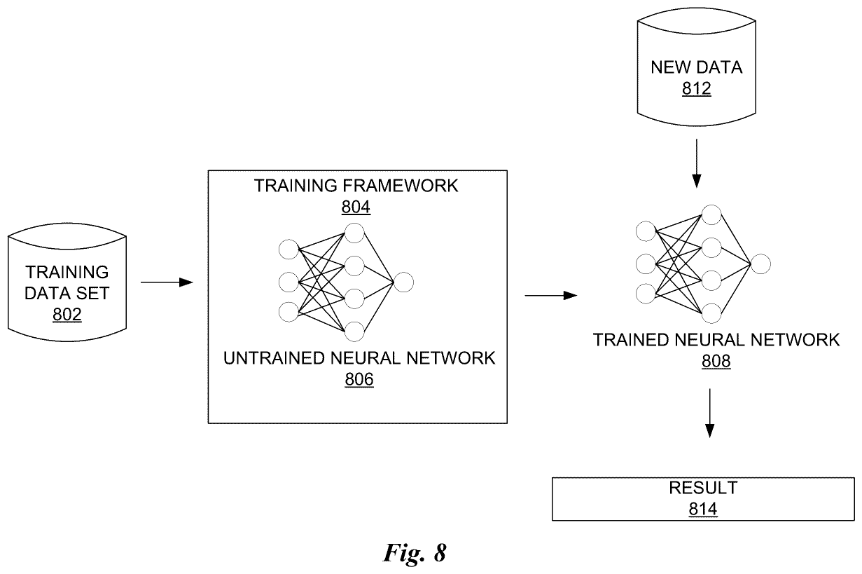

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

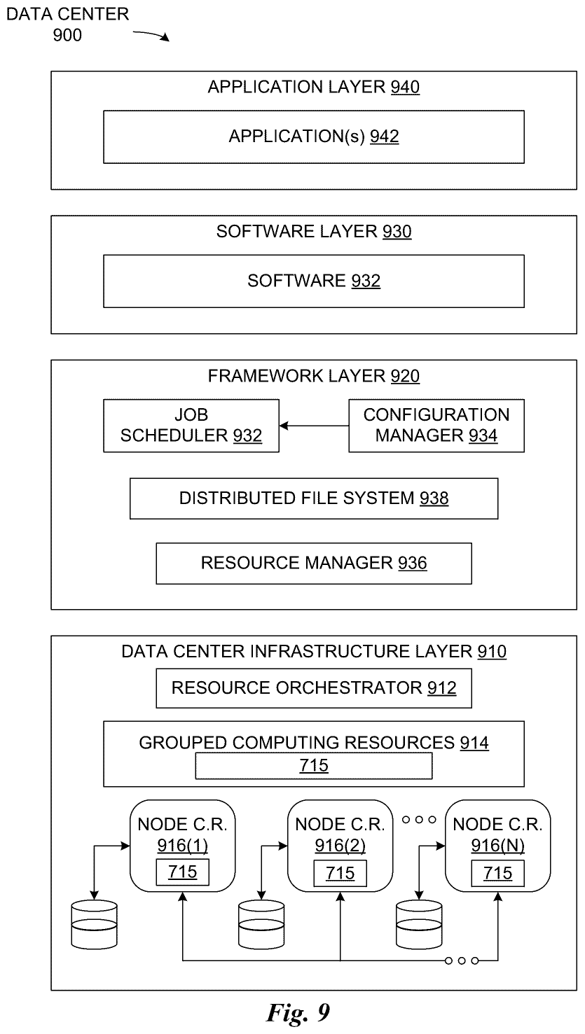

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed to provide a diffusion model that uses variational inferencing to approximate the distribution of data (e.g. to improve a quality of any given image). In accordance with FIGS. 1-6, embodiments may provide a diffusion model usable for performing inferencing operations and for providing inferenced data. The diffusion model may be stored (partially or wholly) in one or both of data storage 701 and 705 in inference and/or training logic 715 as depicted in FIGS. 7A and 7B. Training and deployment of the diffusion model may be performed as depicted in FIG. 8 and described herein. Distribution of the diffusion model may be performed using one or more servers in a data center 900 as depicted in FIG. 9 and described herein.

What is claimed is:

1. A method, comprising:
at a device:
training a diffusion model to be able to improve a quality of any given input image, wherein the training includes:
adding random noise to an input image over a plurality of steps of a forward diffusion process, to form a noisy image; and
learning to remove the noise from the noisy image over a plurality of steps of a reverse diffusion process, wherein one or more aspects of the diffusion model are varied over one or more of the steps of the reverse diffusion process to provide variational inferencing during the reverse diffusion process;
wherein the trained diffusion model is universally able to handle different types of image improvement tasks.

2. The method of claim 1, wherein the different types of image improvement tasks include two or more of:
inpainting,
super-resolution,
deblurring, or
sharpening.

3. The method of claim 1, wherein the different types of image improvement tasks include inpainting to complete a given input incomplete image.

4. The method of claim 1, wherein the different types of image improvement tasks include super-resolution to increase a resolution of a given input image.

5. The method of claim 1, wherein the different types of image improvement tasks include deblurring to remove blurring from a given input image.

6. A method, comprising:
at a device:
processing at least one observation through a reverse denoising diffusion process of a diffusion model to approximate a distribution of data for the at least one observation,
wherein the diffusion model uses variational inference to approximate the distribution of data; and
outputting the distribution of data.

7. The method of claim 6, wherein the at least one observation is included in at least a portion of an image.

8. The method of claim 6, wherein the distribution of data represents an output image.

9. The method of claim 6, wherein the at least one observation includes a masked image.

10. The method of claim 9, wherein the distribution of data represents a non-masked image.

11. The method of claim 6, wherein the at least one observation is a two-dimensional (2D) image.

12. The method of claim 11, wherein the distribution of data represents a three-dimensional (3D) image.

13. The method of claim 6, wherein the at least one observation is in a first resolution, and wherein the distribution of data is in a second resolution that is greater than the first resolution.

14. The method of claim 6, wherein the diffusion model is a generative diffusion prior.

15. The method of claim 6, wherein each timestep of the reverse denoising diffusion process utilizes a corresponding denoiser that is weighted based on a denoising signal-to-noise ratio at the timestep.

16. The method of claim 15, wherein denoiser weights progressively decrease through the reverse denoising diffusion process.

17. The method of claim 6, wherein each timestep of the reverse denoising diffusion process utilizes a corresponding denoiser that applies score-matching regularization to a measurement matching loss.

18. The method of claim 17, wherein the measurement matching loss is a reconstruction loss computed from the at least one observation.

19. The method of claim 17, wherein a diffusion trajectory is used for regularization.

20. The method of claim 6, further comprising, at the device:
processing the distribution of data through a forward denoising diffusion process of the diffusion model to form at least one second observation; and
processing the at least one second observation through the reverse denoising diffusion process to approximate a second distribution of data for the at least one second observation.

21. The method of claim 6, wherein the diffusion model is usable for different downstream tasks.

22. The method of claim 6, wherein the diffusion model is used for inpainting.

23. The method of claim 6, wherein the diffusion model is used for medical imaging.

24. The method of claim 6, wherein the diffusion model is used for image restoration.

25. A system, comprising:
a non-transitory memory storage comprising instructions; and
one or more processors in communication with the memory, wherein the one or more processors execute the instructions to:
process at least one observation through a reverse denoising diffusion process of a diffusion model to approximate a distribution of data for the at least one observation,
wherein the diffusion model uses variational inference to approximate the distribution of data; and
output the distribution of data.

26. The system of claim 25, wherein the at least one observation is included in at least a portion of an image.

27. The system of claim 25, wherein the distribution of data represents an output image.

28. The system of claim 25, wherein each timestep of the reverse denoising diffusion process utilizes a corresponding denoiser that is weighted based on a denoising signal-to-noise ratio at the timestep.

29. The system of claim 28, wherein denoiser weights progressively decrease through the reverse denoising diffusion process.

30. The system of claim 25, wherein each timestep of the reverse denoising diffusion process utilizes a corresponding denoiser that applies score-matching regularization to a measurement matching loss.

31. The system of claim 30, wherein the measurement matching loss is a reconstruction loss computed from the at least one observation.

32. The system of claim 30, wherein a diffusion trajectory is used for regularization.

33. A non-transitory computer-readable media storing computer instructions which when executed by one or more processors of a device cause the device to:
process at least one observation through a reverse denoising diffusion process of a diffusion model to approximate a distribution of data for the at least one observation,
wherein the diffusion model uses variational inference to approximate the distribution of data; and
output the distribution of data.

34. The non-transitory computer-readable media of claim 33, wherein the at least one observation is included in at least a portion of an image.

35. The non-transitory computer-readable media of claim 33, wherein the distribution of data represents an output image.

36. The non-transitory computer-readable media of claim 33, wherein each timestep of the reverse denoising diffusion process utilizes a corresponding denoiser that is weighted based on a denoising signal-to-noise ratio at the timestep.

37. The non-transitory computer-readable media of claim 36, wherein denoiser weights progressively decrease through the reverse denoising diffusion process.

38. The non-transitory computer-readable media of claim 33, wherein each timestep of the reverse denoising diffusion process utilizes a corresponding denoiser that applies score-matching regularization to a measurement matching loss.

39. The non-transitory computer-readable media of claim 38, wherein the measurement matching loss is a reconstruction loss computed from the at least one observation.

40. The non-transitory computer-readable media of claim 38, wherein a diffusion trajectory is used for regularization.
